(19) United States
(12) Patent Application Publication
(10) Pub. No.: US 2003/0163800 A1
(43) Pub. Date: Aug. 28, 2003

(54) System and method for generating graphical codes containing a plurality of data fields

(76) Inventors: Weiyang Zhou, Sandy, UT (US); Darren Smith, Orem, UT (US); Paul Hepworth, Riverton, UT (US); George Powell, Sandy, UT (US); Ryan Hyde, Draper, UT (US)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/373,958

(22) Filed: Feb. 26, 2003

Related U.S. Application Data
(60) Provisional application No. 60/360,245, filed on Feb. 27, 2002.

(51) Int. Cl. G06T 1/00; G06F 15/00; G06F 9/44

(52) U.S. Cl. 717/106; 717/109; 345/501

(57) ABSTRACT

A method for generating a machine-readable graphical code is provided. The method may involve providing a plurality of field identifiers that may be included in the graphical code. The method may also involve receiving a user selection of a subset of the plurality of field identifiers. The method may also involve receiving field contents associated with each field identifier in the subset of the plurality of field identifiers. The method may also involve creating encodable source data by combining the subset of the plurality of field identifiers and the field contents according to predefined rules.

### RELATED APPLICATIONS

This application is related to and claims priority from U.S. patent application Ser. No. 60/360,245 filed Feb. 27, 2002, for “System and Method for Generating Graphical Codes Containing a Plurality of Data Fields,” with inventors Weiyang Zhou, Darren Smith, Paul Hepworth, George Powell, and Ryan Hyde, which is incorporated herein by reference.

### TECHNICAL FIELD

The present invention relates generally to the field of machine-readable graphical codes. More specifically, the present invention relates to a system and method for generating machine-readable graphical codes containing a plurality of data fields.

### BACKGROUND

Computer technology has entered many areas to simplify manual tasks and to make information more readily available. Most people use several computer programs every day that greatly simplify their work day. In addition, through the use of a computer, vast amounts of information are readily available. Computer software and electronic information sources are typically found on storage media or storage devices such as hard drives, CD-ROMs, DVD-ROMs, etc., on a local computer, on a local computer network or a global computer network, such as the Internet.

Computer programs can be used for many purposes including assisting a person in performing his or her job. For example, word processors help computer users prepare documents, spreadsheet programs help users perform accounting functions and numerical analysis, diagnostic programs assist users in diagnosing problems, etc. There are many programs available to help users with almost any need they may have. Typically, computer programs operate upon source data in order to help a user. Thus, the source data is somehow input into the computer program.

One way to input source data into a computer program involves the use of machine-readable graphical codes, such as bar codes, matrix codes, etc. A graphical code is a graphical representation of source data. A user may scan the graphical code with a graphical code reading device which converts the graphical code back into source data. Typically, the graphical code reading device is in electronic communication with a computer program. After the graphical code reading device converts the graphical code into source data, it typically sends the source data to the computer program. The computer program may then use the source data to accomplish one or more tasks.

A graphical code may simply include data. The data may be numbers or alphanumeric strings. For example, a part serial number (e.g., “ABC000198”) may be encoded into one or more machine-readable graphical codes. Alternatively, a graphical code may include a data field. The data field may include a field identifier and field contents associated with that field identifier. An example of a data field may be “SER ABC000198”. In this example, the string “SER” is the field identifier, and the string “ABC000198” is the field contents. The field identifier describes the field contents. For example, the string “SER” describes that “ABC000198” is part serial number.

A graphical code standard is a set of instructions for encoding and decoding graphical codes. The standard may include rules which specify the required format of the data to be encoded, how various data elements should be combined, etc. Examples of graphical code standards include codeXML, SPEC2000, ANSI MH10.8.3, and the like.

Presently, to create a graphical code containing a data field, a user is required to type in both the field identifier and the field contents. This can be problematic because the user needs to know several things about the graphical code standard which is being used (e.g., the required format of the data to be encoded, how various data elements should be combined, etc.). In addition, the structure of the data is not reusable. In each code creation, the user must supply all of the required data. Accordingly, benefits may be realized if means were provided to address one or more of the above problems.

### BRIEF DESCRIPTION OF THE DRAWINGS

The present embodiments will become more fully apparent from the following description and appended claims, taken in conjunction with the accompanying drawings. Understanding that these drawings depict only typical embodiments and are, therefore, not to be considered limiting of the invention's scope, the embodiments will be described with additional specificity and detail through use of the accompanying drawings in which:

FIG. 1 is a block diagram of an embodiment of a system for generating a machine-readable graphical code;

FIG. 2 is a block diagram of an embodiment of a graphical code that may be generated by the graphical code generator;

FIG. 3 is a block diagram of an embodiment of a data field;

FIG. 4 is a flow diagram illustrating an embodiment of a method for generating a machine-readable graphical code;

FIG. 5 is a block diagram of an embodiment of a graphical code generator;

FIG. 6 is a block diagram of an embodiment of a field identifier database;

FIG. 7 illustrates an embodiment of a user interface;

FIG. 8 is a flow diagram illustrating an embodiment of a method for creating encodable source data;

FIG. 9 is a block diagram of an embodiment of a batch file;

FIG. 10 is a flow diagram illustrating another embodiment of a method for creating encodable source data; and

FIG. 11 is a block diagram of hardware components that may be used in an embodiment of a computing device.

### DETAILED DESCRIPTION

It will be readily understood that the components of the embodiments as generally described and illustrated in the Figures herein could be arranged and designed in a wide variety of different configurations. Thus, the following more detailed description of the embodiments of the systems and methods of the present invention, as represented in the Figures, is not intended to limit the scope of the invention, as claimed, but is merely representative of the embodiments of the invention.

Several aspects of the embodiments described herein will be illustrated as software modules stored in a computing device. As used herein, a software module may include any type of computer instruction or computer executable code located within a memory device and/or transmitted as electronic signals over a system bus or network. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction, or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

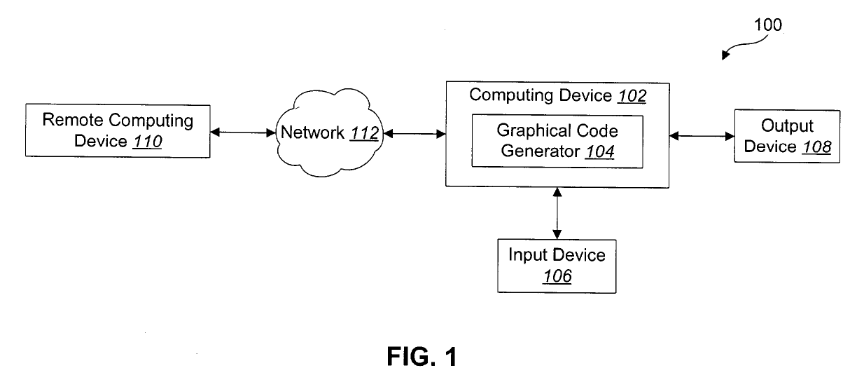

FIG. 1 is a block diagram of an embodiment of a system 100 for generating a machine-readable graphical code. As used herein, a graphical code refers to any type of machine-readable code, including a bar code, a data matrix code, and the like.

As shown in FIG. 1, the system 100 may include a computing device 102. A computing device 102, as used herein, is any device that includes a digital processor capable of receiving and processing data. A computing device 102 includes the broad range of digital computers including microcontrollers, hand-held computers, personal computers, servers, mainframes, supercomputers, and the like.

The computing device 102 may include a graphical code generator 104. The graphical code generator 104 may be a software module, as that term is described above. In general terms, the graphical code generator 104 facilitates creation of graphical codes. Additional details about the operation of various embodiments of the graphical code generator 104 will be provided below.

The system 100 may also include one or more input devices 106 in communication with the computing device 102. The input devices 106 allow data to be input to the computing device 102. Input devices 106 are commercially available and known to those skilled in the art. Examples of input devices 106 include a keyboard, mouse, microphone, game pad, joystick, scanner, and the like.

The system 100 may also include one or more output devices 108 in communication with the computing device 102. The output devices 108 convert data output by the computing device 102 into a format that may be perceived by a user of the computing device 102. Output devices 108 are commercially available and known to those skilled in the art. Examples of output devices 108 include a display screen, printing device, speakers, and the like.

The system 100 may also include a remote computing device 110 in communication with the computing device 102 over a network 112. As used herein, a network 112 refers to any system that facilitates the transmission of data between the computing device 102 and the remote computing device 110. Networks 112 are known to those skilled in the art. Examples of networks 112 include a local area network, a wide area network, a wireless network, the Internet, and the like.

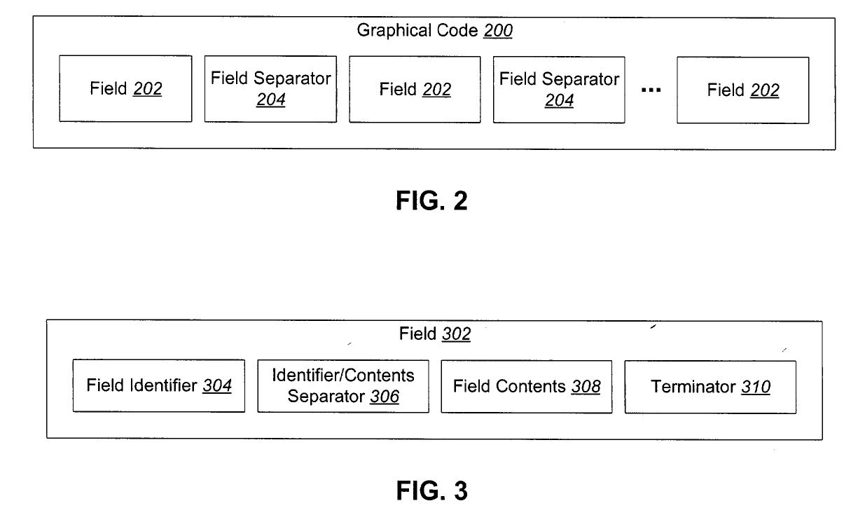

FIG. 2 is a block diagram of an embodiment of a graphical code 200 that may be generated by the graphical code generator 104. As shown in FIG. 2, a graphical code 200 may include a plurality of data fields 202. The graphical code 200 may also include one or more field separators 204 that separate the data fields 202 in the graphical code 200.

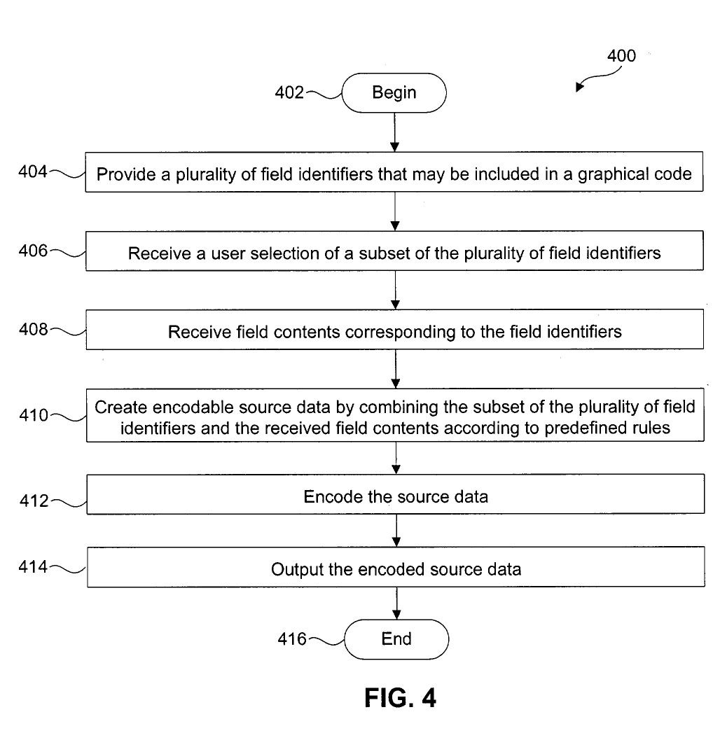

FIG. 3 is a block diagram of an embodiment of a data field 302. As shown in FIG. 3, a data field 302 may include a field identifier 304 and field contents 308. The field identifier 304 includes a description of the field contents 308. For example, if the field contents 308 of a data field 302 included a person's first name (e.g., “John”), the field identifier 304 for that data field 302 may be “First Name.”

The data field 302 may also include an identifier/contents separator 306 and a terminator 310. An identifier/contents separator 306 is a character or a combination of characters that may be used to separate the field identifier 304 and the field contents 308. A terminator 310 is a character or a combination of characters that may be positioned after the field contents 308 in order to terminate the data field 302.

As used herein, the term “separator” may refer to a field separator 204, an identifier/contents separator 306, and/or a terminator 310. Some or all of the separators in a graphical code 200 may be null.

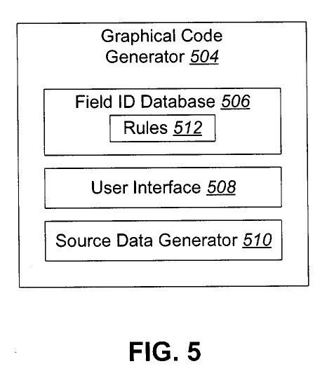

FIG. 4 is a flow diagram illustrating an embodiment of a method 400 for generating a machine-readable graphical code 200. The method 400 may begin 402 by providing 404 a plurality of field identifiers 304 that may be included in a graphical code 200. The method 400 may then involve receiving 406 a user selection of a subset of the plurality of field identifiers 304. As used herein, a “subset” may include any number of the field identifiers 304 provided in step 404, including all of the field identifiers 304 provided in step 404.

The method 400 may then involve receiving 408 field contents 308 associated with each field identifier 304 in the subset of the plurality of field identifiers 304. The method 400 may then involve creating 410 encodable source data by combining the subset of the plurality of field identifiers 304 received in step 406 and the field contents 308 received in step 408 according to predefined rules.

The method 400 may then involve encoding 412 the source data created in step 410. Encoding 412 the source data typically involves transforming the source data to be encoded into the symbol set appropriate for the desired symbology. Error detection and/or correction data may be added to the encoded source data. Many different types of error detection and/or correction algorithms are known in the art. For example, Reed-Solomon error correction may be used for data matrix codes.

The method 400 may then involve outputting 414 the encoded source data. Outputting 414 the encoded source data typically involves producing graphical code elements in the desired symbology that correspond to the encoded source data. The result may be an array of pixels. Dot-gain correction methods may be added to the array of pixels to increase the readability of small size codes on paper or other printing surfaces. The array of pixels may be written to an image file (e.g., TIFF, PNG, BMP, EPS, etc.) and/or printed. The method 400 may then end 416.

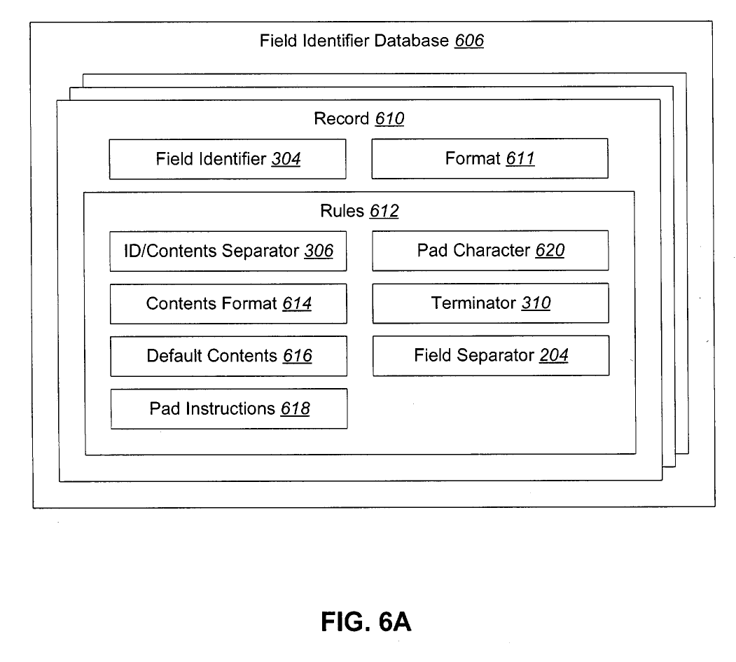

FIG. 5 is a block diagram of an embodiment of the graphical code generator 504. As shown in FIG. 5, the graphical code generator 504 may include rules 512 that specify how the field identifiers 304 may be combined with the field contents 308. In one embodiment, the rules 512 may be part of a field identifier database 506. The rules 512 may be downloaded from the remote computing device 110 over the network 112. The graphical code generator 104 may then request and download the rules 512 from the remote computing device 110 over the network 112.

The graphical code generator 504 may also include a user interface 508. The user interface 508 may be used to provide 404 a plurality of field identifiers 304, receive 406 a user selection of a subset of the plurality of field identifiers 304, and receive 408 field contents 308 associated with the subset of the plurality of field identifiers 304.

The graphical code generator 504 may also include a source data generator 510. The source data generator 510 may be used to combine 410 field identifiers 304 and field contents 308 according to the rules 512.

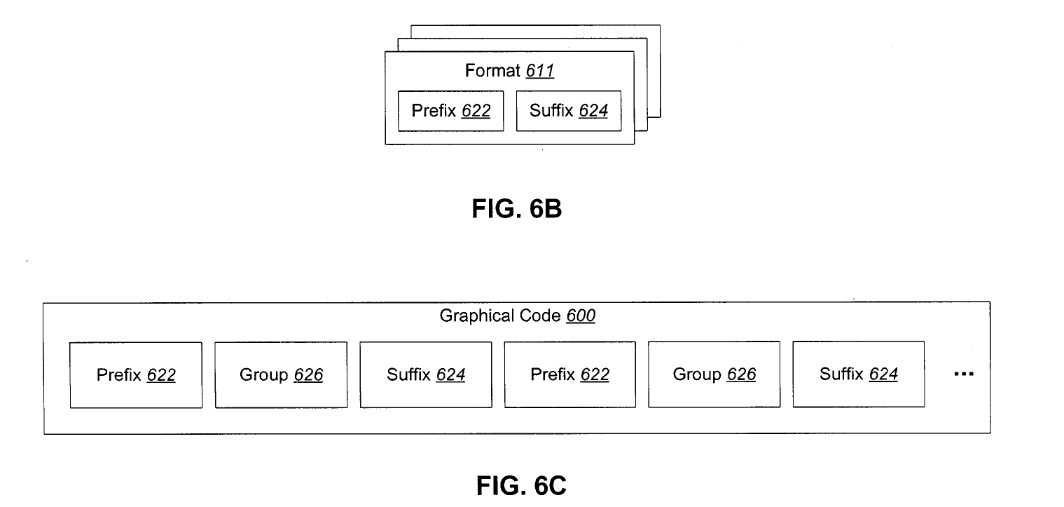

FIG. 6A is a block diagram of an embodiment of a field identifier database 606. The field identifier database 606 may include a plurality of records 610. Each record 610 may include a field identifier 304 and rules 612 associated with the field identifier 304. The rules 612 specify how the field identifier 304 may be combined with the field contents 308. The field identifier 304 and the rules 612 have a format 611 corresponding to a particular graphical code standard. Examples of graphical code standards include codeXML, SPEC 2000, ANSI MH10.8.3, and the like. Multiple field identifier databases 606 may be used to support different graphical code standards.

As shown in FIG. 6A, the rules 612 may include an identifier/contents separator 306. As stated previously, an identifier/contents separator 306 is a character or a combination of characters that may be used to separate the field identifier 304 and the field contents 308.

The rules 612 may include a contents format 614. The contents format 614 includes information about how the field contents 308 are to be formatted. For example, if the field contents 308 include a date, the contents format 614 may be “mm/dd/yyyy.” If the rules 612 include a contents format 614, a user may be required to enter the corresponding field contents 308 according to the contents format 614.

The rules 612 may also include default contents 616. The default contents 616 may include field contents 308 to be included in a data field 202 if no other field contents 308 are available.

The rules 612 may also include pad instructions 618 and a pad character 620. The pad instructions 618 may include information about whether the field contents 308 should be a fixed length, and if so, how field contents 308 shorter than the fixed length should be padded to become the fixed length (i.e., whether the field contents 308 should be padded on the right, padded on the left, etc.). The pad character 620 may specify the character that is to be used to pad the field contents 308.

The rules 612 may also include a terminator 310. As stated previously, a terminator 310 is a character or a combination of characters that may be positioned after the field contents 308 in order to terminate the data field 202. Typically, each data field 202 in a graphical code 200 includes a terminator 310.

The rules 612 may also include a field separator 204. As described previously, a separator 204 may be used to separate the data fields 202 in a graphical code 200. Typically, a separator 204 is not included at the end of the last data field 202 in a graphical code 200.

In some embodiments, there may be a prefix 622 and a suffix 624 for groups of data fields 202 that have the same format 611. As shown in FIG. 6B, each format 611 may be associated with a prefix 622 and a suffix 624.

FIG. 6C is a block diagram of another embodiment of a graphical code 600. The graphical code 600 shown in FIG. 6C includes groups 626 of data fields 202. The data fields 202 within the same group 626 have the same format 611, i.e., the field identifiers 304 and the corresponding rules 612 of the data fields 202 in the group 626 are derived from the same graphical code standard. A prefix 622 precedes each group 626 in the graphical code 600, and a suffix 624 follows each group 626 in the graphical code 600. The prefix 622 that precedes a particular group 626 is the prefix 622 associated with the format 611 of the data fields 202 in the group 626. Similarly, the suffix 624 that follows a particular group 626 is the suffix 624 associated with the format 611 of the data fields 202 in the group 626.

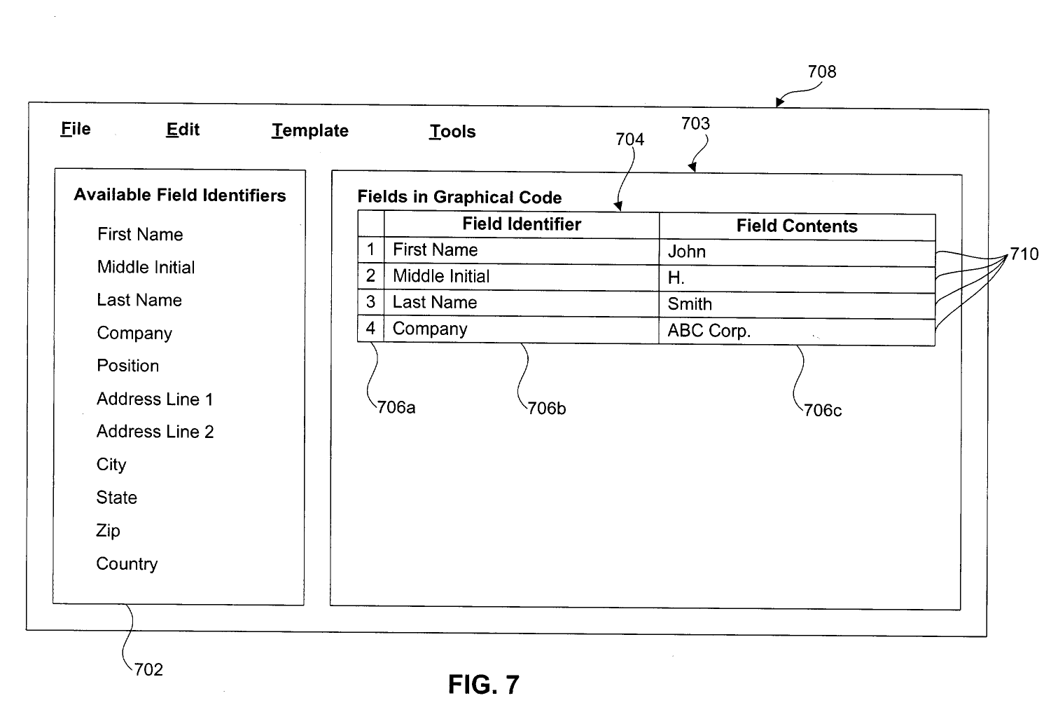

FIG. 7 illustrates an embodiment of the user interface 708. As stated previously, the user interface 708 may be used to provide 404 a plurality of field identifiers 304, receive 406 a user selection of a subset of the plurality of field identifiers 304, and receive 408 field contents 308 associated with the selected field identifiers 304.

As shown in FIG. 7, the user interface 708 may include a display window 702. Providing 404 a plurality of field identifiers 304 may involve displaying a plurality of field identifiers 304 in the display window 702.

The user interface 708 may also include a selection window 703. The selection window 703 may include a table 704. As shown in FIG. 7, the table 704 may include three columns 706a-c: an index column 706a, a field identifier column 706b, and a field contents column 706c. The table 704 may also include a variable number of rows 710.

Receiving 406 a user selection of a subset of the plurality of field identifiers 304 may involve allowing a user to input the subset of the plurality of field identifiers 304 in the selection window 703. In the embodiment shown in FIG. 7, this may involve allowing the user to drag one or more field identifiers 304 from the display window 702 to the field identifier column 706b of the table 704. A new row 710 may be created for each field identifier 304 that is added to the table 704.

Receiving 408 field contents 308 associated with each field identifier 304 in the subset of the plurality of field identifiers 304 may involve allowing a user to input the field contents 308 associated with the selected field identifiers 304 in the selection window 703. In the embodiment shown in FIG. 7, this may involve allowing a user to type the field contents 308 corresponding to the selected field identifiers 304 in the field contents column 706c of the table 704.

In an alternative embodiment, multiple field identifiers 304 may be arranged into groups. In such an embodiment, a group identifier may be associated with each group, and the display window 702 in the user interface 708 may include a list of group identifiers. When the user drags a group identifier from the display window 702 to the selection window 703, all of the field identifiers 304 in the group represented by the group identifier may be added to the table 704 in the selection window 703.

In such an embodiment, different groups may support different graphical code standards. If so, the field identifiers 304 in one group may not be compatible with the field identifiers 304 in another group. In such an embodiment, a mutual exclusion database may be created. When a user selects different groups, the mutual exclusion database may be queried to determine whether the field identifiers 304 in the selected groups are compatible with one another. If two or more field identifiers 304 are incompatible with one another, an error message may be generated.

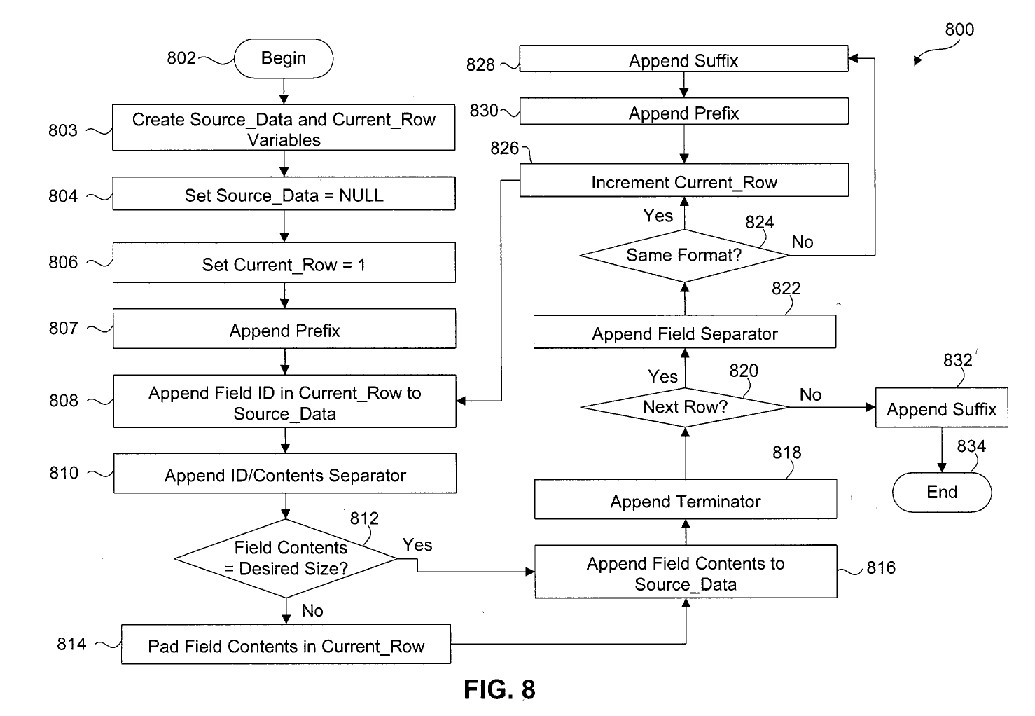

FIG. 8 is a flow diagram illustrating an embodiment of a method 800 for creating 410 encodable source data. The method 800 may be implemented by the source data generator 510. The method 800 may begin 802 by creating 803 a source_data variable and a current_row variable. The source_data variable contains the encodable source data. The current_row variable identifies a row 710 in the table 704. The method 800 may then involve setting 804 the source_data variable to a NULL value, and setting 806 the current_row variable to equal 1.

The method 800 may then involve appending 807 a prefix 622 to the source_data variable. The prefix 622 is associated with the format 611 of the field identifier 304 in the row 710 that corresponds to the current_row variable. The method 800 may then involve appending 808 the field identifier 304 in the row 710 that corresponds to the current_row variable to the source_data variable. For example, if the current_row variable equals 1, then step 808 may involve appending the field identifier 304 in the first row 710 (e.g., “First Name,” in the example shown in FIG. 7) to the source_data variable. The method 800 may then involve appending 810 the identifier/contents separator 306 associated with the field identifier 304 to the source_data variable. The identifier/contents separator 306 may be retrieved from the rules 512.

The method 800 may then involve determining 812 whether the field contents 308 in the row 710 corresponding to the current_row variable are the desired size. The desired size of the field contents 308 may be retrieved from the pad instructions 618 in the field identifier database 606. If the field contents 308 is not the desired size, the method 800 may involve padding 814 the field contents 308 with the pad character 620 according to the pad instructions 618. The method 800 may then involve appending 816 the field contents 308 to the source_data variable. If in step 812 it is determined 812 that the field contents 308 is the desired size, the method 800 may proceed directly to step 816.

The method 800 may then involve appending 818 the terminator 310 associated with the field identifier 304 in the row 710 corresponding to the current_row variable to the source_data variable. The terminator 310 may be retrieved from the field identifier database 606.

The method 800 may then involve determining 820 whether there is a next row 710 in the table 704. If there is, the method 800 may involve appending 822 the field separator 204 associated with the field identifier 304 in the current row 710 to the source_data variable. It may then be determined 824 whether the data field 202 that corresponds to the next row 710 is in the same format 611 as the data field 202 that corresponds to the current row 710. If the format 611 is the same, the method 800 may involve incrementing 826 the current_row variable, and then returning to step 808 and proceeding as described above. If the format 611 is not the same, the method 800 may involve appending 828 the suffix 624 associated with the format 611 of the field identifier 304 in the current row 710 to the source_data variable, and then appending 830 the prefix 622 associated with the format 611 of the field identifier 304 in the next row 710 to the source_data variable. The current_row variable may then be incremented 826, and the method 800 may then involve returning to step 808 and proceeding as described above.

If in step 820 it is determined that there is not a next row 710 in the table 704, the method 800 may involve appending 832 the suffix 624 associated with the format 611 of the field identifier 304 in the current row 710 to the source_data variable. The method 800 may then end.

As described previously, receiving 406 a user selection of field identifiers 304 and receiving 408 field contents 308 associated with the selected field identifiers 304 may involve allowing a user to input field identifiers 304 and field contents 308 in a selection window 703 of a user interface 708. Another way to receive 406 a user selection of field identifiers 304 and to receive 408 field contents 308 associated with the selected field identifiers 304 may involve reading the field identifiers 304 and field contents 308 from a batch file 900.

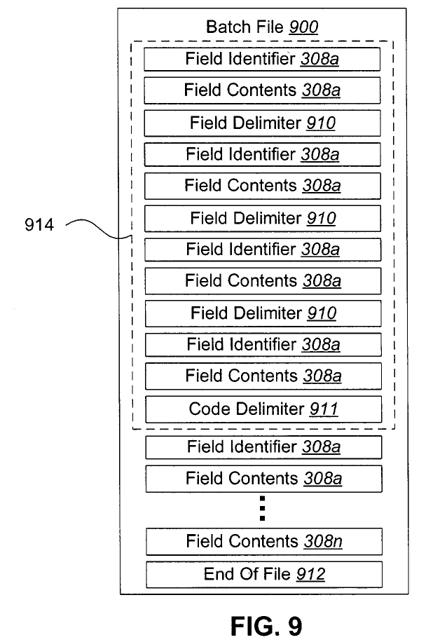

FIG. 9 is a block diagram of an embodiment of a batch file 900. The batch file 900 includes a plurality of field identifiers 304 and field contents 308, separated by delimiters 910. The batch file 900 may also include an end of file designation 912 which designates that the end of the batch file 900 has been reached.

In the embodiment shown in FIG. 9, the field identifiers 304 and field contents 308 within the dotted lines 914 will be included in a single graphical code 200. The next four field identifiers 304 and field contents 308 will be included in another graphical code 200, and so on. In the embodiment shown in FIG. 9, four field contents 308 are shown within the dotted lines 914 in order to correspond to the number of field identifiers 304 and field contents 308 in the example shown in FIG. 7. Of course, a graphical code 200 may include any number of data fields 202 (and therefore any number of field identifiers 304 and field contents 308).

In one embodiment, two different delimiters 910 may be used: a field delimiter 910 to separate data fields 202 that correspond to the same graphical code 200, and a code delimiter 911 to separate data fields 202 that correspond to different graphical codes 200. For example, a first character (e.g., a comma) may be used to separate data fields 202 that correspond to the same graphical code 200, and a second character (e.g., a space) may be used to separate data fields 202 that correspond to different graphical codes 200.

The batch file 900 may also include additional information not shown in FIG. 9. For example, the batch file 900 may include a filename for the graphical code 200, the size of the graphical code 200, etc.

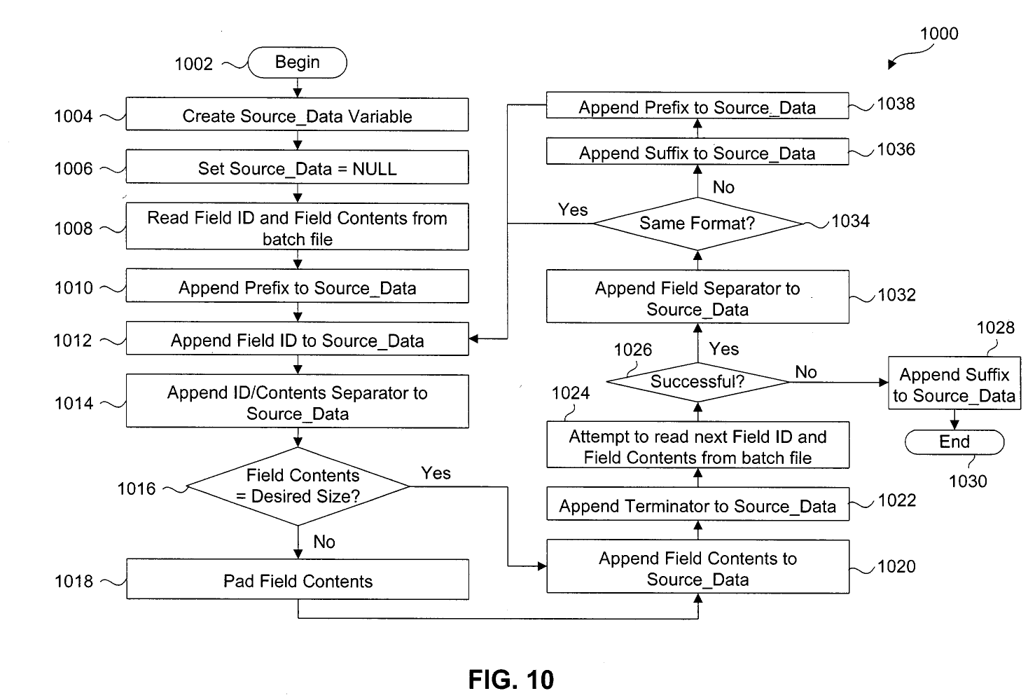

FIG. 10 is a flow diagram illustrating another embodiment of a method 1000 for creating 410 encodable source data. As before, the method 1000 may be implemented by the source data generator 510.

The method 1000 may begin 1002 by creating 1004 a source_data variable. The source_data variable contains the encodable source data. The method 1000 may then involve setting 1006 the source_data variable to a NULL value.

The method 1000 may then involve reading 1008 the first field identifier 304 and field contents 308 from the batch file 900. The prefix 622 associated with the format 611 of the field identifier 304 may then be appended 1010 to the source_data variable. The field identifier 304 may then be appended 1012 to the source_data variable. The identifier/contents separator 306 may then be appended 1014 to the source_data variable.

It may then be determined 1016 whether the field contents 308 read from the batch file 900 are the desired size. As before, the desired size of the field contents 308 may be retrieved from the pad instructions 618 in the field identifier database 606. If the field contents 308 are not the desired size, the method 1000 may involve padding 1018 the field contents 308 with the pad character 620 according to the pad instructions 618. The method 1000 may then involve appending 1020 the field contents 308 to the source_data variable. If in step 1016 it is determined that the field contents 308 are the desired size, the method 1000 may proceed directly to step 1020.

The method 1000 may then involve appending 1022 the terminator 310 associated with the field identifier 304 to the source_data variable. As before, the terminator 310 may be retrieved from the field identifier database 606.

The method 1000 may then involve attempting 1024 to read the next field identifier 304 and field contents 308 from the batch file 900. If it is determined 1026 that this attempt is not successful (e.g., if the end of file designation 912 is reached), the suffix 624 associated with the format 611 of the field identifier 304 may be appended 1028 to the source_data variable, and the method 1000 may end 1030.

If it is determined 1026 that the next field identifier 304 and field contents 308 have been successfully read 1024 from the batch file 900, a field separator 204 may be appended 1032 to the source_data variable. It may then be determined 1034 whether the next field identifier 304 is in the same format 611 as the previous field identifier 304. If so, the method 1000 may return to step 1012 and proceed as described above. If not, the method 1000 may involve appending 1036 the suffix 624 associated with the format 611 of the previous field identifier 304 to the source_data variable. The prefix 622 associated with the format 611 of the current field identifier 304 may then be appended 1038 to the source_data variable. The method 1000 may then return to step 1012 and proceed as described above.

In some embodiments, the user interface 708 and the batch file 900 may be used. For example, a user may input the field identifiers 304 by means of a user interface 708, and the field contents 308 may be read from a batch file 900. Alternatively, the field identifiers 304 may be read from a batch file 900, and a user may input the field contents 308 by means of a user interface 708.

In another alternative embodiment, the source data generator 510 may read some field contents 308 from the table 704 and other field contents 308 from the batch file 900. In such an embodiment, each row 710 in the table may have a batch attribute associated with it. If the row 710 has a batch attribute associated with it, the source data generator 510 will read the field contents 308 from the batch file 900. If the row 710 does not have the batch attribute associated with it, the source data generator 510 will read the field contents 308 from the table 704.

In another alternative embodiment, the table 704 may be saved as a template file. In such an embodiment, the source data generator 510 may read the field identifiers 304 from the template file instead of the table 704. The template file may also include additional information about the graphical code 200, such as the file format, size, whether dot-gain correction should be utilized, etc.

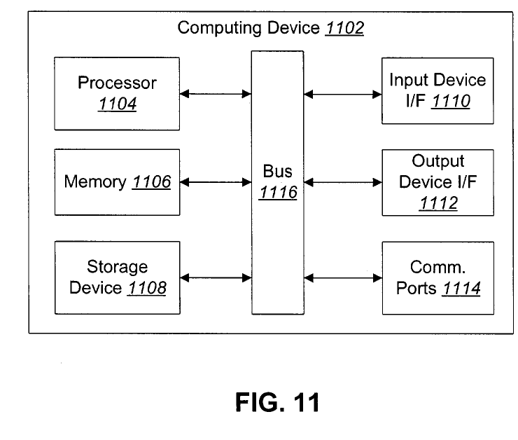

FIG. 11 is a block diagram of hardware components that may be used in an embodiment of a computing device 1102. Many different types of computer systems may be used to implement the computing device 1102 illustrated herein. The diagram of FIG. 11 illustrates typical components of a computing device 1102 including a processor 1104, memory 1106, a storage device 1108, an input device interface 1110, an output device interface 1112, and one or more communication ports 1114. A bus 1116 electronically couples all of the components in the computing device 1102. Each of these components is known to those skilled in the art.

It will be appreciated by those skilled in the art that more components may be included in the computing device 1102. For example, several input device interfaces 1110 may be included, such as a keyboard interface, a mouse interface, a joystick interface, etc. In addition, several output device interfaces 1112 may be included such as a display screen interface, a printer interface, etc. Thus, those skilled in the art will appreciate that additional components may be added to the computing device 1102 without detracting from the functionality to serve as a computing device.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A method for generating a machine-readable graphical code, comprising:
providing a plurality of field identifiers;
receiving a user selection of a subset of the plurality of field identifiers;
receiving field contents associated with each field identifier in the subset of the plurality of field identifiers; and
creating encodable source data by combining the subset of the plurality of field identifiers and the field contents according to predefined rules.

2. The method of claim 1, further comprising:
transforming the encodable source data into a symbol set corresponding to a graphical code symbology to create encoded source data; and
producing graphical code elements in the graphical code symbology that correspond to the encoded source data.

3. The method of claim 1, wherein providing the plurality of field identifiers comprises displaying the plurality of field identifiers in a display window of a user interface.

4. The method of claim 1, wherein receiving the user selection comprises:
providing a selection window in a user interface; and
allowing a user to input the subset of the plurality of field identifiers in the selection window.

5. The method of claim 1, wherein receiving the field contents comprises:
providing a selection window in a user interface; and
allowing a user to input the field contents in the selection window.

6. The method of claim 1, wherein receiving the field contents comprises reading the field contents from a batch file.

7. The method of claim 1, wherein receiving the user selection of the subset of the plurality of field identifiers comprises reading the subset from a batch file.

8. The method of claim 1, wherein combining the subset of the plurality of field identifiers and the field contents comprises creating a plurality of data fields, each data field in the plurality of data fields comprising:
a field identifier from the subset of the plurality of field identifiers; and
field contents associated with the field identifier.

9. The method of claim 8, wherein the rules comprise a plurality of separators, and wherein each field identifier in the plurality of field identifiers is associated with a separator from the plurality of separators.

10. The method of claim 9, wherein each data field in the plurality of data fields further comprises an identifier/contents separator and a terminator, and wherein adjacent data fields are separated by a field separator.

11. The method of claim 1, wherein:
the subset of the plurality of field identifiers comprises a group of field identifiers associated with an encoding format;
the rules comprise a prefix and a suffix associated with the encoding format; and
creating encodable source data further comprises adding the prefix and the suffix to the group of field identifiers.

12. The method of claim 1, further comprising downloading the predefined rules from a remote computing device over a network.

13. A method for generating a plurality of machine-readable graphical codes, comprising:
providing a plurality of field identifiers;
receiving a user selection of a subset of the plurality of field identifiers;
receiving field contents associated with each field identifier in the subset of the plurality of field identifiers;
generating a first graphical code, the first graphical code comprising a first data field comprising:
a first field identifier from the subset of the plurality of field identifiers; and
first field contents associated with the first field identifier; and
generating a second graphical code, the second graphical code comprising a second data field comprising:
the first field identifier; and
second field contents associated with the first field identifier.

14. The method of claim 13, wherein receiving the field contents comprises reading the field contents from a batch file.

15. The method of claim 13, wherein receiving the user selection of the subset of the plurality of field identifiers comprises reading the subset from a batch file.

16. A computing device for generating a machine-readable graphical code, comprising:
a processor;
memory in electronic communication with the processor;
a graphical code generator stored in the memory, the graphical code generator being programmed to implement a method comprising:
providing a plurality of field identifiers;
receiving a user selection of a subset of the plurality of field identifiers;
receiving field contents associated with each field identifier in the subset of the plurality of field identifiers; and
creating encodable source data by combining the subset of the plurality of field identifiers and the field contents according to predefined rules.

17. The computing device of claim 16, wherein the method further comprises:
transforming the encodable source data into a symbol set corresponding to a graphical code symbology to create encoded source data; and
producing graphical code elements in the graphical code symbology that correspond to the encoded source data.

18. The computing device of claim 16, wherein providing the plurality of field identifiers comprises displaying the plurality of field identifiers in a display window of a user interface.

19. The computing device of claim 16, wherein receiving the user selection comprises:
providing a selection window in a user interface; and
allowing a user to input the subset of the plurality of field identifiers in the selection window.

20. The computing device of claim 16, wherein receiving the field contents comprises:
providing a selection window in a user interface; and
allowing a user to input the field contents in the selection window.

21. The computing device of claim 16, wherein receiving the field contents comprises reading the field contents from a batch file.

22. The computing device of claim 16, wherein receiving the user selection of the subset of the plurality of field identifiers comprises reading the subset from a batch file.

23. The computing device of claim 16, wherein combining the subset of the plurality of field identifiers and the field contents comprises creating a plurality of data fields, each data field in the plurality of data fields comprising:
a field identifier from the subset of the plurality of field identifiers; and
field contents associated with the field identifier.

24. The computing device of claim 23, wherein the rules comprise a plurality of separators, and wherein each field identifier in the plurality of field identifiers is associated with a separator from the plurality of separators.

25. The computing device of claim 24, wherein each data field in the plurality of data fields further comprises an identifier/contents separator and a terminator, and wherein adjacent data fields are separated by a field separator.

26. The computing device of claim 16, wherein:
the subset of the plurality of field identifiers comprises a group of field identifiers associated with an encoding format;
the rules comprise a prefix and a suffix associated with an encoding format; and
creating encodable source data further comprises adding the prefix and the suffix to the group of field identifiers.

27. The computing device of claim 16, wherein the method further comprises downloading the predefined rules from a remote computing device over a network.

28. A computing device for generating a plurality of machine-readable graphical codes, comprising:
a processor;
memory in electronic communication with the processor;
a graphical code generator stored in the memory, the graphical code generator being programmed to implement a method comprising:
providing a plurality of field identifiers;
receiving a user selection of a subset of the plurality of field identifiers;
receiving field contents associated with each field identifier in the subset of the plurality of field identifiers;
generating a first graphical code, the first graphical code comprising a first data field comprising:
a first field identifier from the subset of the plurality of field identifiers; and
first field contents associated with the first field identifier; and
generating a second graphical code, the second graphical code comprising a second data field comprising:
the first field identifier; and
second field contents associated with the first field identifier.

29. The computing device of claim 28, wherein receiving the field contents comprises reading the field contents from a batch file.

30. The computing device of claim 28, wherein receiving the user selection of the subset of the plurality of field identifiers comprises reading the subset from a batch file.

31. A computer-readable medium for storing program data, wherein the program data comprises executable instructions for implementing a method comprising:
providing a plurality of field identifiers;
receiving a user selection of a subset of the plurality of field identifiers;
receiving field contents associated with each field identifier in the subset of the plurality of field identifiers; and
creating encodable source data by combining the subset of the plurality of field identifiers and the field contents according to predefined rules.

32. The computer-readable medium of claim 31, wherein the method further comprises:
transforming the encodable source data into a symbol set corresponding to a graphical code symbology to create encoded source data; and
producing graphical code elements in the graphical code symbology that correspond to the encoded source data.

33. The computer-readable medium of claim 31, wherein providing the plurality of field identifiers comprises displaying the plurality of field identifiers in a display window of a user interface.

34. The computer-readable medium of claim 31, wherein receiving the user selection comprises:
providing a selection window in a user interface; and
allowing a user to input the subset of the plurality of field identifiers in the selection window.

35. The computer-readable medium of claim 31, wherein receiving the field contents comprises:
providing a selection window in a user interface; and
allowing a user to input the field contents in the selection window.

36. The computer-readable medium of claim 31, wherein receiving the field contents comprises reading the field contents from a batch file.

37. The computer-readable medium of claim 31, wherein receiving the user selection of the subset of the plurality of field identifiers comprises reading the subset from a batch file.

38. The computer-readable medium of claim 31, wherein combining the subset of the plurality of field identifiers and the field contents comprises creating a plurality of data fields, each data field in the plurality of data fields comprising:
a field identifier from the subset of the plurality of field identifiers; and
field contents associated with the field identifier.

39. The computer-readable medium of claim 38, wherein the rules comprise a plurality of separators, and wherein each field identifier in the plurality of field identifiers is associated with a separator from the plurality of separators.

40. The computer-readable medium of claim 39, wherein each data field in the plurality of data fields further comprises an identifier/contents separator and a terminator, and wherein adjacent data fields are separated by a field separator.

41. The computer-readable medium of claim 31, wherein:
the subset of the plurality of field identifiers comprises a group of field identifiers associated with an encoding format;
the rules comprise a prefix and a suffix associated with the encoding format; and
creating encodable source data further comprises adding the prefix and the suffix to the group of field identifiers.

42. The computer-readable medium of claim 31, wherein the method further comprises downloading the predefined rules from a remote computing device over a network.

43. A computer-readable medium for storing program data, wherein the program data comprises executable instructions for implementing a method comprising:
providing a plurality of field identifiers;
receiving a user selection of a subset of the plurality of field identifiers;
receiving field contents associated with each field identifier in the subset of the plurality of field identifiers;
generating a first graphical code, the first graphical code comprising a first data field comprising:
a first field identifier from the subset of the plurality of field identifiers; and
first field contents associated with the first field identifier; and
generating a second graphical code, the second graphical code comprising a second data field comprising:
the first field identifier; and
second field contents associated with the first field identifier.

44. The computer-readable medium of claim 43, wherein receiving the field contents comprises reading the field contents from a batch file.

45. The computer-readable medium of claim 43, wherein receiving the user selection of the subset of the plurality of field identifiers comprises reading the subset from a batch file.
